(19) United States
(12) Patent Application Publication
(10) Pub. No.: US 2022/0357455 A1
(43) Pub. Date: Nov. 10, 2022

(54) DISTANCE MEASURING SENSOR, DISTANCE MEASURING SYSTEM, AND ELECTRONIC EQUIPMENT

(71) Applicant: SONY SEMICONDUCTOR SOLUTIONS CORPORATION, KANAGAWA (JP)

(72) Inventor: KUMIKO MAHARA, KANAGAWA (JP)

(21) Appl. No.: 17/756,204

(22) PCT Filed: Nov. 13, 2020
(86) PCT No.: PCT/JP2020/042401

§ 371 Date: May 19, 2022

(30) Foreign Application Priority Data
Nov. 29, 2019 (JP) 2019-216556

(51) Int. Cl. G01S 17/894; G01S 17/18; G01S 7/4865; G01S 7/4863

(52) U.S. Cl. CPC G01S 17/894; G01S 17/18; G01S 7/4865; G01S 7/4863

(57) ABSTRACT

The present technology relates to a distance measuring sensor, a distance measuring system, and electronic equipment adapted to change light emission conditions at high speed.

The distance measuring sensor includes a pixel array section configured to have pixels arrayed two-dimensionally, each of the pixels receiving reflected light from an object under irradiation light from a lighting apparatus and outputting a detection signal corresponding to an amount of the received light, and a control section configured to control a light emission condition for the lighting apparatus according to an operation of each of the pixels in the pixel array section. This technology can be applied, for example, to a distance measuring system for measuring the distance to a subject being imaged.

### TECHNICAL FIELD

The present technology relates to a distance measuring sensor, a distance measuring system, and electronic equipment. More particularly, the technology relates to a distance measuring sensor, a distance measuring system, and electronic equipment adapted to change light emission conditions at high speed.

### BACKGROUND ART

In recent years, advances in semiconductor technology have contributed to miniaturization of distance measuring modules that measure the distance to an object. This has helped to incorporate a distance measuring module in a mobile terminal such as a smartphone, which is a small-size information processing apparatus equipped with communication functions, for example.

One exemplary distance measuring method for use by the distance measuring module is the indirect ToF (Time of Flight) method. The indirect ToF method involves emitting irradiation light to an object, detecting reflected light from the surface of the irradiated object under the irradiation light, and calculating the distance to the object on the basis of the time of flight from the time the irradiation light is emitted until the reflected light is received.

In measuring the time of flight, the distance measuring sensor receiving the reflected light supplies a lighting apparatus that emits the irradiation light with a light emission timing for light emission timing control (e.g., see PTL 1).

### CITATION LIST

### Patent Literature

[PTL 1]

PCT Patent Publication No. WO2019/044487

### SUMMARY

### Technical Problem

Although control of the light emission timing by the distance measuring sensor has already been practiced as disclosed in PTL 1, light emission conditions such as light emission intensity are controlled by a broader-concept host. In a case where the light emission conditions are changed, it takes a certain amount of time for the distance measuring sensor to address the changed light emission conditions.

The present technology has been devised in view of the above circumstances and makes it possible to change light emission conditions at high speed.

### Solution to Problem

According to one aspect of the present technology, there is provided a distance measuring sensor including a pixel array section and a control section. The pixel array section has pixels arrayed two-dimensionally, each of the pixels receiving reflected light from an object under irradiation light from a lighting apparatus and outputting a detection signal corresponding to an amount of the received light. The control section controls a light emission condition for the lighting apparatus according to an operation of each of the pixels in the pixel array section.

According to a second aspect of the present technology, there is provided a distance measuring system including a lighting apparatus configured to emit irradiation light to an object, and a distance measuring sensor configured to receive reflected light from the object under the irradiation light. The distance measuring sensor includes a pixel array section and a control section. The pixel array section has pixels arrayed two-dimensionally, each of the pixels receiving the reflected light and outputting a detection signal corresponding to an amount of the received light. The control section controls a light emission condition for the lighting apparatus according to an operation of each of the pixels in the pixel array section.

According to a third aspect of the present technology, there is provided electronic equipment including a distance measuring system, the distance measuring system including a lighting apparatus configured to emit irradiation light to an object and a distance measuring sensor configured to receive reflected light from the object under the irradiation light. The distance measuring sensor includes a pixel array section and a control section. The pixel array section has pixels arrayed two-dimensionally, each of the pixels receiving the reflected light and outputting a detection signal corresponding to an amount of the received light. The control section controls a light emission condition for the lighting apparatus according to an operation of each of the pixels in the pixel array section.

According to the first through the third aspects of the present technology, the reflected light from the object under the irradiation light from the lighting apparatus is received by each of the pixels arrayed two-dimensionally in the pixel array section, each of the pixels outputting the detection signal corresponding to the amount of the received light. The light emission condition for the lighting apparatus is controlled in keeping with an operation of each of the pixels.

The distance measuring sensor, the distance measuring system, and the electronic equipment may each be implemented either as an independent apparatus or as a module to be incorporated in another apparatus.

### BRIEF DESCRIPTION OF DRAWINGS

FIG. 1 is a block diagram depicting an exemplary configuration of a distance measuring system to which the present technology is applied.

FIG. 2 is a diagram explaining the distance measuring principle of the indirect ToF method.

FIG. 3 is another diagram explaining the distance measuring principle of the indirect ToF method.

FIG. 4 is a block diagram depicting an exemplary detailed configuration of a lighting apparatus and a distance measuring sensor.

FIG. 5 is a diagram explaining details of a pixel array section.

FIG. 6 is a diagram explaining examples in which irradiation light is changed.

FIG. 7 is a diagram explaining other examples in which irradiation light is changed.

FIG. 8 is a sequence diagram depicting a first control example in which a change of light emission conditions is carried out.

FIG. 9 is a sequence diagram depicting a second control example in which a change of light emission conditions is carried out.

FIG. 10 is a diagram explaining a specific transmission timing at which light source setting information is transmitted to the lighting apparatus.

FIG. 11 is a block diagram depicting an exemplary detailed configuration of the lighting apparatus and a first modification example of the distance measuring sensor.

FIG. 12 is a block diagram depicting an exemplary detailed configuration of the lighting apparatus and a second modification example of the distance measuring sensor.

FIG. 13 is a flowchart explaining a light emission condition control process performed by the first modification example of the distance measuring sensor.

FIG. 14 is a perspective diagram depicting an exemplary chip configuration of the distance measuring sensor.

FIG. 15 is a block diagram of a distance measuring system as a comparative example that performs another light emission control method.

FIG. 16 is a block diagram depicting an exemplary configuration of electronic equipment to which the present technology is applied.

FIG. 17 is a block diagram depicting an example of schematic configuration of a vehicle control system.

FIG. 18 is a diagram of assistance in explaining an example of installation positions of an outside-vehicle information detecting section and an imaging section.

### DESCRIPTION OF EMBODIMENTS

Some modes for implementing the present technology (referred to as embodiments hereunder) are described below with reference to the accompanying drawings. It is to be noted that, throughout the ensuing description and the drawings, the constituent elements having substantially identical functions and configurations are assigned the same reference signs, and the redundant explanations are not repeated. The description is made in the following order:
1. Exemplary schematic configuration of the distance measuring system
2. Distance measuring principle of the indirect ToF method
3. Exemplary configuration of the distance measuring sensor and the lighting apparatus
4. Exemplary timing for changing the light emission conditions
5. First modification example of the distance measuring sensor
6. Second modification example of the distance measuring sensor
7. Flowchart of the light emission condition control process
8. Exemplary chip configuration of the distance measuring sensor
9. Comparisons with other light emission control methods
10. Examples of application to electronic equipment
11. Examples of application to mobile objects

### <1. Exemplary Schematic Configuration of the Distance Measuring System>

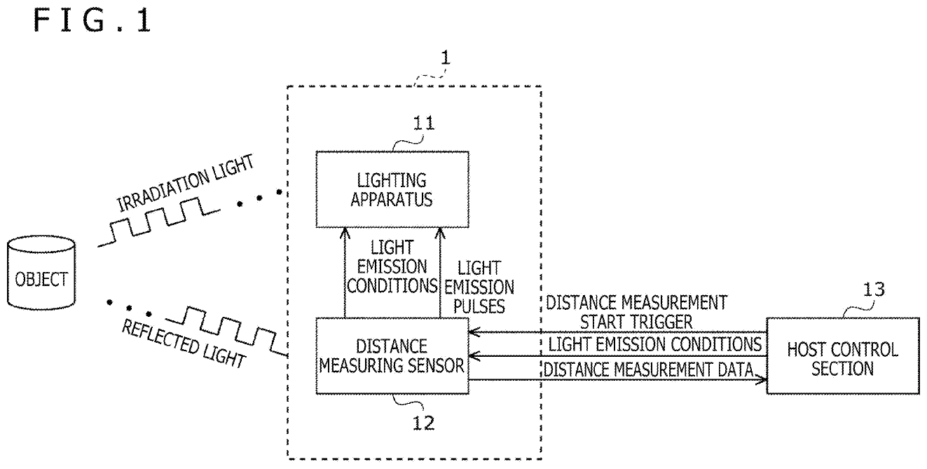

FIG. 1 is a block diagram depicting an exemplary configuration of a distance measuring system to which the present technology is applied.

A distance measuring system 1 includes a lighting apparatus 11 and a distance measuring sensor 12. The distance measuring system 1 measures the distance to a predetermined object as a subject being imaged under instructions from a host control section 13 that controls a host apparatus in which the distance measuring system 1 is incorporated. The distance measuring system 1 outputs measured distance data to the host control section 13.

More specifically, the lighting apparatus 11 has an infrared laser diode as a light source, for example. On the basis of light emission pulses and light emission conditions supplied from the distance measuring sensor 12, the lighting apparatus 11 emits irradiation light to the predetermined object as the subject being imaged. The light emission pulses constitute a predetermined modulation frequency (e.g., 20 MHz) pulse signal indicative of a light emission (ON/OFF) timing. The light emission conditions include, for example, light source setting information such as light emission intensity, an irradiation area, and an irradiation method. The lighting apparatus 11 emits light that is modulated to reflect the light emission pulses under the light emission conditions supplied from the distance measuring sensor 12.

The distance measuring sensor 12 acquires a distance measurement start trigger designating the start of distance measurement and the light emission conditions from the host control section 13, and feeds the acquired light emission conditions to the lighting apparatus 11. At the same time, the distance measuring sensor 12 generates light emission pulses and supplies the lighting apparatus 11 therewith, thereby controlling light emission of the lighting apparatus 11.

Also, on the basis of the generated light emission pulses, the distance measuring sensor 12 receives reflected light from the object under irradiation light from the lighting apparatus 11, generates distance measurement data on the basis of the result of the light reception, and outputs the generated distance measurement data to the host control section 13.

The host control section 13 controls the entire host apparatus in which the distance measuring system 1 is incorporated. The host control section 13 supplies the distance measuring sensor 12 with the light emission conditions under which the lighting apparatus 11 emits the irradiation light and a distance measurement start trigger designating the start of distance measurement. In response to the distance measurement start trigger, the distance measuring sensor 12 supplies the distance measurement data. The host control section 13 includes, for example, an arithmetic unit such as a CPU (central processing unit), an MPU (microprocessor unit), or an FPGA (field-programmable gate array)) incorporated in the host apparatus, or an application program that runs on the arithmetic unit. Further, in a case where the host apparatus is constituted by a smartphone, for example, the host control section 13 includes an AP (application processor) or an application program that runs thereon.

The distance measuring system 1 configured as described above performs distance measurement by use of a predetermined distance measuring method such as the indirect ToF (Time of Flight) method, the direct ToF method, or the Structured Light method on the basis of the result of reception of the reflected light. The indirect ToF method involves detecting as a phase difference the time of flight from the time irradiation light is emitted until the reflected light is received and thereby calculating the distance to the object. The direct ToF method involves directly measuring the time of flight from the time irradiation light is emitted until the reflected light is received and thereby calculating the distance to the object. The Structured Light method involves projecting pattern light as the irradiation light and calculating the distance to the object on the basis of distortions in the received pattern light.

The distance measuring method to be performed by the distance measuring system 1 is not limited to anything specific. The paragraphs that follow describe how the distance measuring system 1 operates specifically in distance measurement using the indirect ToF method, for example.

### <2. Distance Measuring Principle of the Indirect ToF Method>

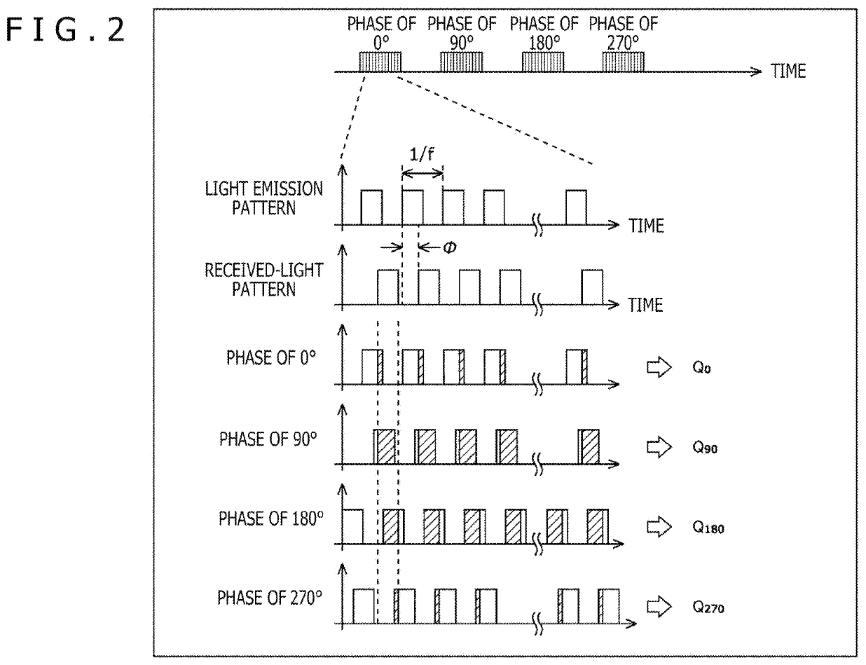

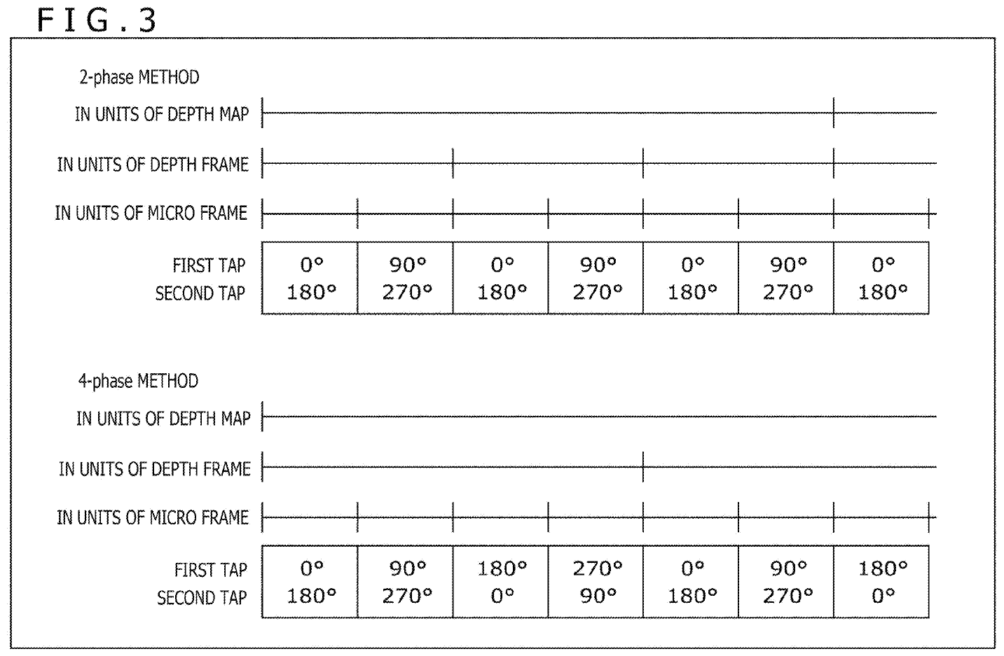

First, the distance measuring principle of the indirect ToF method is briefly explained with reference to FIGS. 2 and 3.

A depth value d[mm] corresponding to the distance from the distance measuring system 1 to the object is calculated by the following mathematical expression (1).

[Math. 1]

d=1/2·c·Δt (1)

The symbol Δt in the mathematical expression (1) denotes the time it takes for the irradiation light from the lighting apparatus 11 to be reflected by the object and enter the distance measuring sensor 12. The symbol c represents light speed.

Adopted as the irradiation light from the lighting apparatus 11 is pulsed light with a light emission pattern that repeatedly turns on and off at high speed according to a predetermined modulation frequency f. One cycle T of the light emission pattern is defined as 1/f. The distance measuring sensor 12 detects a phase shift of the reflected light (received-light pattern) according to the time Δt required for the irradiation light from the lighting apparatus 11 to reach the distance measuring sensor 12. If the symbol φ is assumed to represent the amount of phase shift (phase difference) between the light emission pattern and the receive-light pattern, the time Δt is calculated by the following mathematical expression (2).

$$\begin{matrix}[ Math . 2 ] & \\ Δ t = \frac{1}{f} \cdot \frac{ϕ}{2 π} & ( 2 )\end{matrix}$$

Therefore, given the mathematical expressions (1) and (2) above, the depth value d from the distance measuring system 1 to the object is calculated by the following mathematical expression (3).

$$\begin{matrix}[ Math . 3 ] & \\ d = \frac{c ϕ}{4 π f} & ( 3 )\end{matrix}$$

What follows is an explanation of how to calculate the above-mentioned phase difference φ.

Each of pixels in a pixel array formed in the distance measuring sensor 12 repeatedly turns on and off at high speed in keeping with the modulation frequency. In so doing, the pixels accumulate electrical charges only during ON periods.

The distance measuring sensor 12 successively changes the ON/OFF execution timing of each of the pixels in the pixel array to accumulate electrical charges at each execution timing, thereby outputting detection signals reflecting the accumulated charges.

For example, there are four kinds of ON/OFF execution timings: a timing with a phase of 0 degrees, a timing with a phase of 90 degrees, a timing with a phase of 180 degrees, and a timing with a phase of 270 degrees.

The execution timing with the phase of 0 degrees is a timing at which the ON timing (light reception timing) of each of the pixels in the pixel array is in phase with the pulsed light emitted by the lighting apparatus 11, i.e., in phase with the light emission pattern.

The execution timing with the phase of 90 degrees is a timing at which the ON timing (light reception timing) of each of the pixels in the pixel array is 90 degrees out of phase behind the pulsed light emitted by the lighting apparatus 11 (light emission pattern).

The execution timing with the phase of 180 degrees is a timing at which the ON timing (light reception timing) of each of the pixels in the pixel array is 180 degrees out of phase behind the pulsed light emitted by the lighting apparatus 11 (light emission pattern).

The execution timing with the phase of 270 degrees is a timing at which the ON timing (light reception timing) of each of the pixels in the pixel array is 270 degrees out of phase behind the pulsed light emitted by the lighting apparatus 11 (light emission pattern).

For example, the distance measuring sensor 12 successively changes the light reception timings with the phases of 0, 90, 180, and 270 degrees in this order. In so doing, the distance measuring sensor 12 acquires the amount of the reflected light received (accumulated charges) at each light reception timing. In FIG. 2, at the light reception timings with different phases (ON timings), time periods in which reflected light is incident are shaded with slashes.

As depicted in FIG. 2, it is assumed that the electrical charges accumulated at the light reception timings with the phases of 0, 90, 180, and 270 degrees are represented by Q₀, Q₉₀, Q₁₈₀, and Q₂₇₀, respectively. The phase difference φ is then calculated by the following mathematical expression (4) using Q₀, Q₉₀, Q₁₈₀, and Q₂₇₀.

$$\begin{matrix}[ Math . 4 ] & \\ ϕ = Arc tan \frac{{Q}_{90} - {Q}_{270}}{{Q}_{180} - {Q}_{0}} & ( 4 )\end{matrix}$$

The depth value d from the distance measuring system 1 to the object can be calculated by inputting the phase difference φ calculated by the mathematical expression (4) into the expression (3) above.

Confidence conf is the value indicative of the intensity of the light received by each pixel. This value is calculated, for example, by the following mathematical expression (5).

[Math. 5]

conf=\sqrt{(Q₁₈₀−Q₀)²+(Q₉₀−Q₂₇₀)²} (5)

The distance measuring sensor 12 calculates the depth value d from the distance measuring system 1 to the object on the basis of the detection signals supplied from each of the pixels in the pixel array. The distance measuring sensor 12 then generates a depth map and a confidence map for output to the outside, the depth map storing the depth value d as a pixel value of each pixel, the confidence map storing the confidence conf as a pixel value of each pixel.

The distance measuring sensor 12 has two charge accumulating sections for each of the pixels in the pixel array, as will be discussed later. If the two charge accumulating sections are called a first tap and a second tap, the first tap and the second tap are alternately used for electrical charge accumulation. This permits acquisition of detection signals, in one frame, at two light reception timings with phases inverted to each other, such as the phases of 0 degrees and 180 degrees, for example.

Here, the distance measuring sensor 12 generates and outputs the depth map and the confidence map, using either a 2-Phase method or a 4-Phase method.

The upper part in FIG. 3 depicts how a depth map is generated by use of the 2-Phase method.

With the 2-Phase method, as illustrated in the upper part of FIG. 3, the detection signals of the phases of 0 and 180 degrees are acquired in a first frame, and the detection signals of the phases of 90 and 270 degrees are obtained in a second frame that follows. This provides the detection signals of four phases, allowing the depth value d to be calculated by the mathematical expression (3) above.

With the 2-Phase method, if the unit (one frame) in terms of which the detection signals of the phases of 0 and 180 degrees or the detection signals of the phases of 90 and 270 degrees are generated is called a micro frame, two micro frames provide four-phase data. The depth value d can then be calculated in units of a pixel by using the data of two micro frames. If the frame in which the depth value d is stored as the pixel value of each pixel is called a depth frame, one depth frame is constituted by two micro frames.

Furthermore, the distance measuring sensor 12 acquires multiple depth frames by changing the light emission conditions such as the light emission intensity and the modulation frequency and, using these depth frames, eventually generates a depth map. That is, one depth map is generated using multiple depth frames. In the example of FIG. 3, a depth map is generated by use of three depth frames. Alternatively, each depth frame may be output unchanged as the depth map. That is, one depth map may be constituted by one depth frame.

The lower part of FIG. 3 depicts how a depth map is generated by the 4-Phase method.

With the 4-Phase method, as illustrated in the lower part of FIG. 3, a first frame and a second frame are followed by a third frame in which the detection signals of the phases of 180 and 0 degrees are acquired, and by a fourth frame in which the detection signals of the phases of 270 and 90 degrees are acquired. That is, in each of the first tap and the second tap, the detection signals of all four phases of 0, 90, 180, and 270 degrees are acquired, with the depth value d calculated by the mathematical expression (3) above. With the 4-Phase method, one depth frame is thus constituted by four micro frames, with each depth map generated using multiple depth frames under different light emission conditions.

The 4-Phase method permits acquisition of the detection signals of all four phases in each tap (first tap and second tap). This can remove uneven characteristics between taps that exist in each pixel, i.e., differences in sensitivity between taps.

On the other hand, the 2-Phase method can provide the depth value d to the object by using the data of two micro frames. This makes it possible to perform distance measurement twice as fast as the 4-Phase method. The uneven characteristics between the taps can be adjusted by correction parameters such as gains and offsets.

Whereas the distance measuring sensor 12 can be driven either by the 2-Phase method or by the 4-Phase method, the distance measuring sensor 12 is assumed below to be driven by the 2-Phase method for the purpose of simplification.

### <3. Exemplary Configuration of the Distance Measuring Sensor and the Lighting Apparatus>

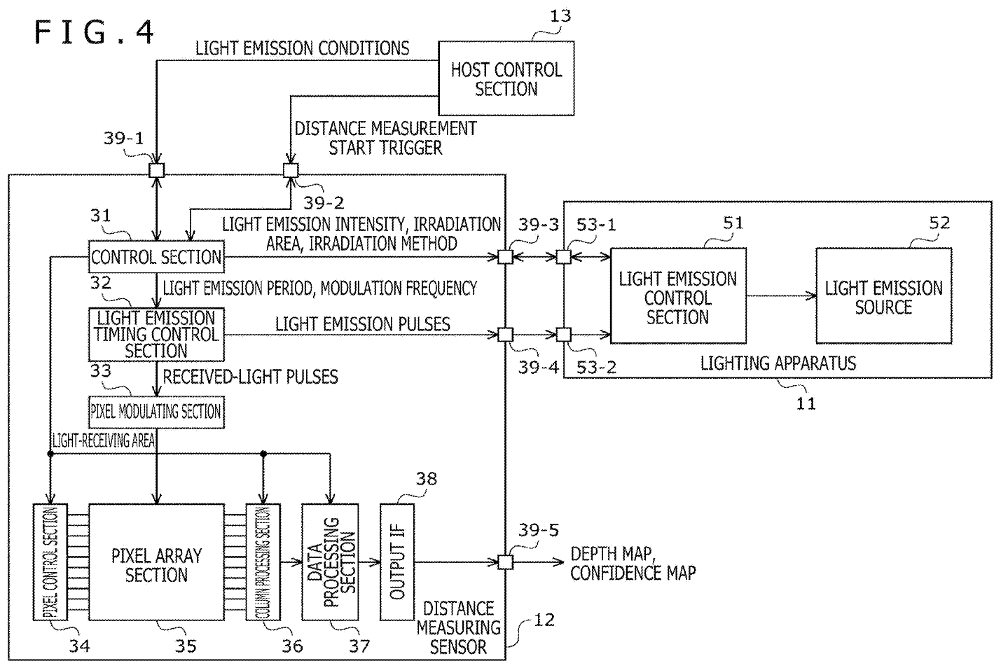

FIG. 4 is a block diagram depicting an exemplary detailed configuration of the lighting apparatus 11 and the distance measuring sensor 12. It is to be noted that, for the purpose of easy understanding, FIG. 4 also depicts the host control section 13.

The distance measuring sensor 12 includes a control section 31, a light emission timing control section 32, a pixel modulating section 33, a pixel control section 34, a pixel array section 35, a column processing section 36, a data processing section 37, an output IF 38, and input/output terminals 39-1 through 39-5.

The lighting apparatus 11 includes a light emission control section 51, a light emission source 52, and input/output terminals 53-1 and 53-2.

The control section 31 of the distance measuring sensor 12 is supplied with the light emission conditions from the host control section 13 via the input/output terminal 39-1. The control section 31 is also fed with the distance measurement start trigger from the host control section 13 via the input/output terminal 39-2. On the basis of the light emission conditions and the distance measurement start trigger, the control section 31 controls the operation of the distance measuring sensor 12 as a whole as well as that of the lighting apparatus 11.

More specifically, on the basis of the light emission conditions supplied from the host control section 13, the control section 31 sends information such as the light emission intensity, the irradiation area, and the irradiation method making up part of the light emission conditions to the lighting apparatus 11 as the light source setting information via the input/output terminal 39-3.

Also, given the light emission conditions from the host control section 13, the control section 31 supplies the light emission timing control section 32 with the information regarding a light emission period and the modulation frequency constituting part of the light emission conditions. The light emission period represents an exposure time per phase.

Furthermore, in keeping with the irradiation area and irradiation method, among others, fed to the lighting apparatus 11, the control section 31 supplies drive control information including a light-receiving area of the pixel array section 35 to the pixel control section 34, the column processing section 36, and the data processing section 37.

The light emission timing control section 32 generates light emission pulses on the basis of the information of the light emission period and modulation frequency fed from the control section 31. The light emission timing control section 32 supplies the generated light emission pulses to the lighting apparatus 11 via the input/output terminal 39-4. The light emission pulses constitute a pulse signal of the modulation frequency supplied from the control section 31. An integral time of High-periods in one micro-frame of the light emission pulses constitutes the light emission period supplied from the control section 31. The light emission pulses are supplied to the lighting apparatus 11 via the input/output terminal 39-4 in a manner timed with the distance measurement start trigger from the host control section 13.

In synchronism with the light emission pulses, the light emission timing control section 32 generates received-light pulses for receiving the reflected light and feeds the generated received-light pulses to the pixel modulating section 33. The received-light pulses, as described above, constitute the pulse signal that is 0, 90, 180, or 270 degrees out of phase behind the light emission pulses.

On the basis of the received-light pulses supplied from the light emission timing control section 32, the pixel modulating section 33 changes charge accumulation operations between the first tap and the second tap for each of the pixels in the pixel array section 35.

On the basis of the drive control information supplied from the control section 31, the pixel control section 34 controls such operations as an accumulated charge reset operation and a read operation on each of the pixels in the pixel array section 35. For example, in keeping with the light-receiving area supplied as part of the drive control information from the control section 31, the pixel control section 34 can drive only a part of the light-receiving area including the whole pixels. As another example, the pixel control section 34 can perform control to thin out at predetermined intervals the detection signals from each of the pixels in the light-receiving area or to add up the detection signals from multiple pixels (pixel addition).

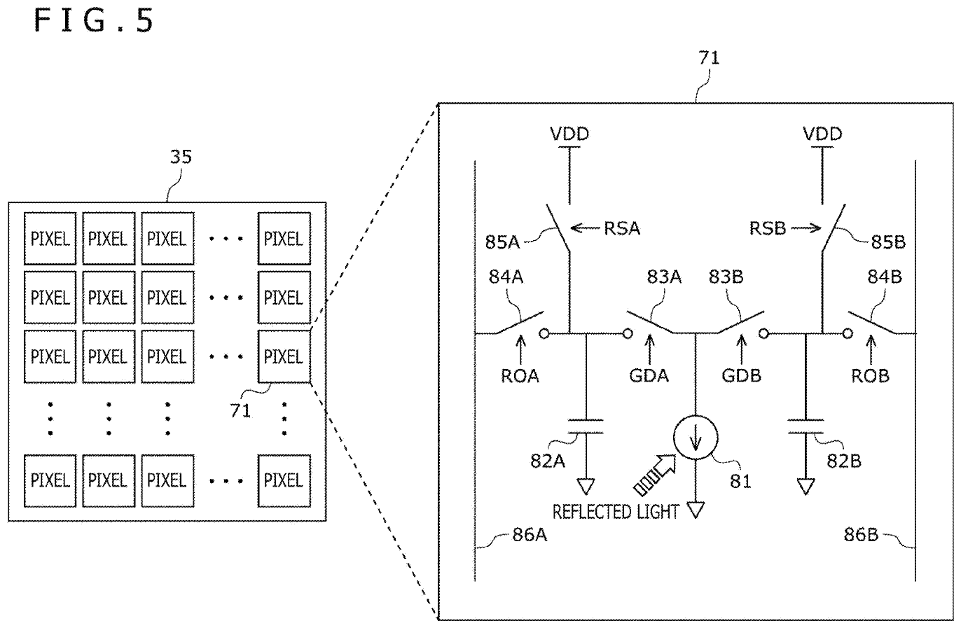

The pixel array section 35 has multiple pixels 71 (FIG. 5) arrayed in a two-dimensional matrix. Each of the pixels 71 in the pixel array section 35 receives reflected light under control of the pixel modulating section 33 and the pixel control section 34, and supplies the column processing section 36 with the detection signal corresponding to the amount of received light.

The pixel array section 35 is explained below in detail with reference to FIG. 5.

As depicted in FIG. 5, the pixel array section 35 has multiple pixels 71 arrayed in a two-dimensional matrix.

Each pixel 71 includes a photodiode 81, an FD (Floating Diffusion) section 82A as a charge accumulating section corresponding to the first tap, and an FD (Floating Diffusion) section 82B as a charge accumulating section corresponding to the second tap.

The pixel 71 further includes multiple pixel transistors for controlling the accumulation of charges in the FD section 82A as the first tap, i.e., a transfer transistor 83A, a selection transistor 84A, and a reset transistor 85A, as well as multiple pixel transistors for controlling the accumulation of charges in the FD section 82B as the second tap, i.e., a transfer transistor 83B, a selection transistor 84B, and a reset transistor 85B.

The operation of the pixel 71 is explained below.

First, a reset operation is carried out to reset excess charges before the start of exposure. Specifically, the pixel control section 34 brings selection signals GDA and GDB as well as reset signals RSA and RSB High to turn on the transfer transistor 83A and the reset transistor 85A on the first tap side and the transfer transistor 83B and the reset transistor 85B on the second tap side. This operation resets the charges accumulated in the FD sections 82A and 82B as well as in the photodiode 81. After the end of the reset operation, the transfer transistor 83A and the reset transistor 85A as well as the transfer transistor 83B and the reset transistor 85B on the second tap side are turned back off.

Next, an exposure operation is started. Specifically, the pixel modulating section 33 brings distribution signals GDA and GDB High alternately in synchronism with the received-light pulses to alternately turn on the transfer transistor 83A on the first tap side and the transfer transistor 83B on the second tap side. This distributes the charges generated by the photodiode 81 either to the FD section 82A as the first tap or to the FD section 82B as the second tap. The operation of distributing the charges generated by the photodiode 81 to the first tap or to the second tap is repeated periodically during the time corresponding to the light emission period of one micro frame. The charges transferred via the transfer transistor 83A are successively accumulated in the FD section 82A, and the charges transferred via the transfer transistor 83B are successively accumulated in the FD section 82B.

After the end of the exposure period, the pixel control section 34 brings selection signals ROA and ROB High, thereby outputting to the column processing section 36 the detection signal corresponding to the charges accumulated in the FD section 82A as the first tap and the detection signal corresponding to the charges accumulated in the FD section 82B as the second tap. That is, when the selection transistor 84A is turned on according to the selection signal ROA, a detection signal A reflecting the amount of electrical charges accumulated in the FD section 82A is output from the pixel 71 via a signal line 86A. Likewise, when the selection transistor 84B is turned on according to the selection signal ROB, a detection signal B reflecting the amount of electrical charges accumulated in the FD section 82B is output from the pixel 71 via a signal line 86B.

In such a manner, the pixel 71 outputs the detection signals A and B by distributing the charges generated by the reflected light received by the photodiode 81 either to the first tap or to the second tap in keeping with the delay time ΔT. Each of the detection signals A and B is any one of the detection signals of the above-mentioned phases of 0, 90, 180, and 270 degrees.

Described with reference to FIG. 4 again, the column processing section 36 includes multiple AD (Analog to Digital) converting sections. The AD converting section provided corresponding to each of pixel columns in the pixel array section 35 performs a noise removal process and an AD conversion process on the detection signals output from any of the pixels 71 in the corresponding pixel column. The detection signals having undergone the AD conversion process are supplied to the data processing section 37.

The data processing section 37 calculates the depth value d for each pixel 71 on the basis of the detection signals of the pixel 71 supplied from the column processing section 36 following the AD conversion process, thereby generating a depth frame that holds the depth value d as the pixel value of each pixel. The data processing section 37 further generates a depth map using at least one depth frame. On the basis of the detection signals from each pixel 71, the data processing section 37 calculates the confidence conf, thereby generating a confidence frame corresponding to the depth frame holding the confidence conf as the pixel value of each pixel as well as a confidence map corresponding to the depth map. The data processing section 37 supplies the output IF 38 with the depth map and confidence map thus generated.

The output IF 38 converts the depth map and confidence map fed from the data processing section 37 into a signal format (e.g., MIPI: Mobile Industry Processor Interface) of the input/output terminal 39-5 for output therethrough. The depth map and confidence map output from the input/output terminal 39-5 are supplied to the host control section 13 as the distance measurement data.

Although there are multiple input/output terminals 39-1 through 39-5 and multiple input/output terminals 53-1 and 53-2 in FIG. 4 for reasons of descriptive convenience, these terminals may be constituted by a single terminal having multiple input/output contacts (as a terminal group). It is also possible to set the light emission conditions and the light source setting information by using serial communication such as an SPI (Serial Peripheral Interface) or I2C (Inter-Integrated Circuit). In the case where the SPI or I2C serial communication is used, the distance measuring sensor 12 acts as the master side. As such, the distance measuring sensor 12 can set the light source setting information for the lighting apparatus 11 at a desired timing. Using the serial communication such as the SPI or I2C makes it possible to provide complex and detailed settings by use of registers.

The light emission control section 51 in the lighting apparatus 11 is configured with a laser driver, for example. The light emission control section 51 drives the light emission source 52 on the basis of the light source setting information and light emission pulses supplied from the distance measuring sensor 12 via the input/output terminals 53-1 and 53-2.

The light emission source 52 includes at least one laser light source such as a VCSEL (Vertical Cavity Surface Emitting Laser). The light emission source 52 emits irradiation light on the basis of the predetermined light emission intensity, irradiation area, irradiation method, modulation frequency, and light emission period under drive control of the light emission control section 51.

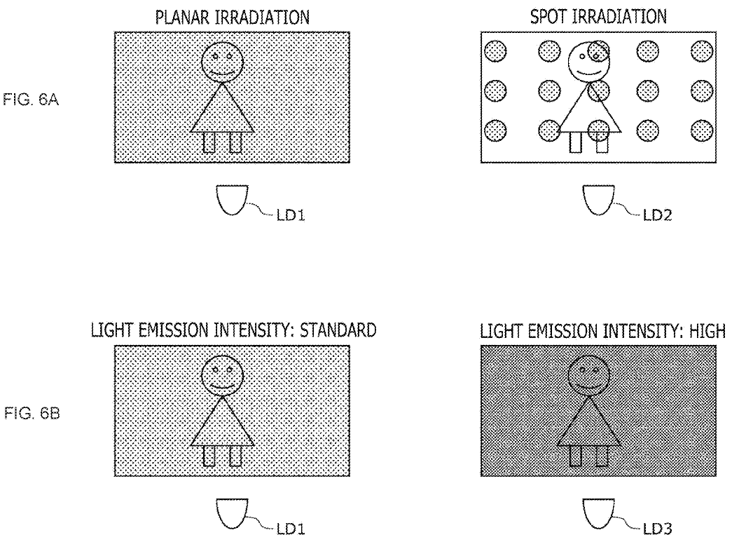

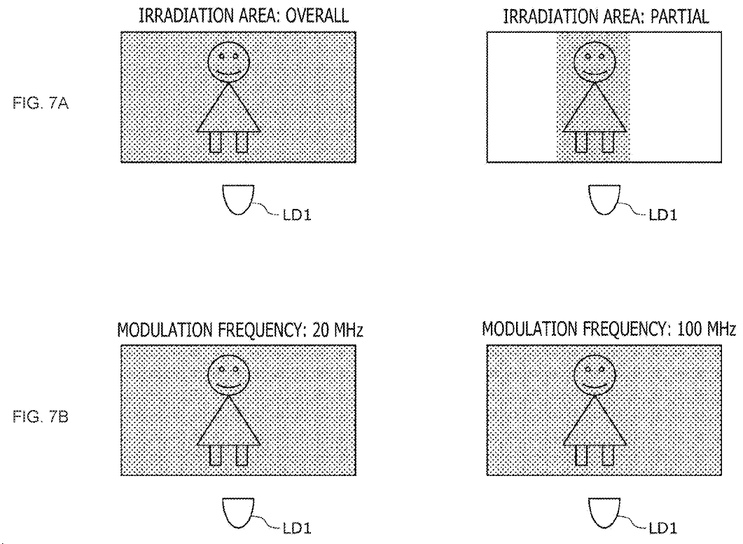

FIGS. 6 and 7 depict examples in which the light emission control section 51 changes irradiation light on the assumption that the light emission source 52 has three kinds of laser light sources LD1 through LD3 with different light emission characteristics.

Subfigure A in FIG. 6 depicts an example in which the light emission control section 51 changes the irradiation method for irradiation light.

Specifically, the light emission control section 51 changes the irradiation method by switching between a first laser light source LD1 and a second laser light source LD2, the first laser light source LD1 performing planar irradiation on a predetermined irradiation area with uniform light emission intensity within a predetermined luminance range, the second laser light source LD2 carrying out spot irradiation on multiple spots (circles) as irradiation areas at a predetermined distance apart.

Subfigure B in FIG. 6 depicts an example in which the light emission control section 51 changes the light emission intensity of irradiation light.

Specifically, the light emission control section 51 changes the light emission intensity by switching between the first laser light source LD1 and a third laser light source LD3, the first laser light source LD1 performing planar irradiation with predetermined light emission intensity (standard light emission intensity), the third laser light source LD3 carrying out planar irradiation with a light emission intensity level higher than that of the first laser light source LD1.

It is to be noted that the light emission intensity can be changed either by the method of changing the laser light sources LD or by a method of changing voltages supplied to one laser light source LD (e.g., laser light source LD1).

Subfigure A in FIG. 7 depicts an example in which the light emission control section 51 changes the irradiation area for irradiation light.

Specifically, the light emission control section 51 changes the irradiation area by switching between overall irradiation and partial irradiation, the overall irradiation involving irradiating the whole area that can be irradiated by the first laser light source LD1, the partial irradiation involving limiting the irradiation area. The irradiation area for the partial irradiation may be a central portion of the whole area that can be irradiated, for example. The irradiation area can be changed by, for example, driving a diffuser panel or a projection lens disposed in front of the first laser light source LD1. Alternatively, in a case where the first laser light source LD1 is constituted by multiple light-emitting elements, the irradiation area can be restricted by causing a limited portion of the limit-emitting elements to emit light.

Subfigure B in FIG. 7 depicts an example in which the light emission control section 51 changes the modulation frequency of irradiation light.

Specifically, by use of the first laser light source LD1, the light emission control section 51 changes the modulation frequency by switching between irradiation for emitting light at a modulation frequency of 20 MHz and irradiation for emitting light at a modulation frequency of 100 MHz. The change of the modulation frequency is achieved by varying the frequency of the light emission pulses supplied from the distance measuring sensor 12.

Whereas the examples explained with reference to FIGS. 6 and 7 are ones in which only one light emission condition is changed, it is obviously possible to change a desired combination of multiple light emission conditions simultaneously. For example, it is possible to change the light emission intensity and the modulation frequency simultaneously, or both the light emission intensity and the irradiation area at the same time.

There need not be only one laser light source LD that is caused to light. Two or more laser light sources may be caused simultaneously to emit light. For example, the first laser light source LD1 having the standard light emission intensity may be caused to emit light simultaneously with the third laser light source LD3 having a light emission intensity level higher than that of the first laser light source LD1. This makes it possible to provide irradiation with a light emission intensity level higher than that of the third laser light source LD3 only.

### <4. Exemplary Timing for Changing the Light Emission Conditions>

Explained next is the timing at which the distance measuring sensor 12 changes the light emission conditions for the lighting apparatus 11.

The distance measuring sensor 12 acquires the light emission conditions from the host control section 13, and at an appropriate timing commensurate with the operation of its own (i.e., of the distance measuring sensor 12), performs a change of light emission conditions for the lighting apparatus 11.

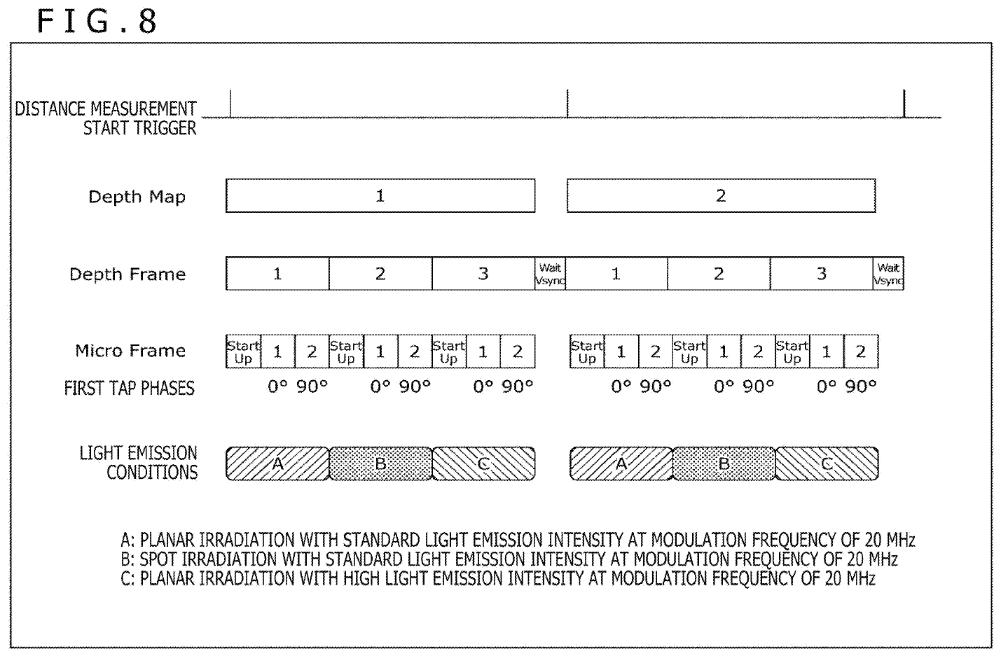

FIG. 8 is a sequence diagram depicting a first control example in which the distance measuring sensor 12 carries out a change of light emission conditions for the lighting apparatus 11.

The example in FIG. 8 is one in which the distance measuring sensor 12 generates three depth frames under three kinds of light emission conditions A, B, and C, generates one depth map from the three depth frames, and outputs the generated depth map. Since two micro frames are necessary for one depth frame in the case of the 2-Phase method, one depth map is generated by use of a total of six micro frames.

Before being supplied with the distance measurement start trigger from the host control section 13, the control section 31 in the distance measuring sensor 12 acquires a set of three kinds of light emission conditions A, B, and C from the host control section 13 and stores the acquired light emission conditions in an internal memory. Here, the light emission condition A is assumed to be used for performing overall irradiation with the standard light emission intensity at the modulation frequency of 20 MHz, for example. The light emission condition B is assumed to be used for carrying out spot irradiation with the standard light emission intensity at the modulation frequency of 20 MHz, for example. The light emission condition C is assumed to be used for effecting overall irradiation with a high light emission intensity level at the modulation frequency of 20 MHz, for example.

When supplied with the distance measurement start trigger from the host control section 13, the control section 31 and the light emission timing control section 32 in the distance measuring sensor 12 first output to the lighting apparatus 11 the light source setting information and light emission pulses corresponding to the light emission condition A. The control section 31 and the light emission timing control section 32 thus cause the lighting apparatus 11 to emit irradiation light under the light emission condition A. At the same time, these sections issue received-light pulses to drive each of the pixels 71 in the pixel array section 35, thereby starting reception of light.

Following a predetermined sensor startup operation (StartUp), the distance measuring sensor 12 receives reflected light under the light emission condition A. In so doing, the distance measuring sensor 12 generates a first micro frame of the phases of 0 and 180 degrees and then a second micro frame of the phases of 90 and 270 degrees. The distance measuring sensor 12 proceeds to generate a first depth frame on the basis of the first micro frame and the second micro frame.

The control section 31 and the light emission timing control section 32 in the distance measuring sensor 12 then output to the lighting apparatus 11 the light source setting information and light emission pulses corresponding to the light emission condition B. The control section 31 and the light emission timing control section 32 thus cause the lighting apparatus 11 to emit irradiation light under the light emission condition B. At the same time, these sections issue received-light pulses to drive each of the pixels 71 in the pixel array section 35, thereby starting reception of light.

Following the predetermined sensor startup operation (StartUp), the distance measuring sensor 12 receives reflected light under the light emission condition B. In so doing, the distance measuring sensor 12 generates a first micro frame of the phases of 0 and 180 degrees and then a second micro frame of the phases of 90 and 270 degrees. The distance measuring sensor 12 proceeds to generate a second depth frame on the basis of the first micro frame and the second micro frame.

The control section 31 and the light emission timing control section 32 in the distance measuring sensor 12 then output to the lighting apparatus 11 the light source setting information and light emission pulses corresponding to the light emission condition C. The control section 31 and the light emission timing control section 32 thus cause the lighting apparatus 11 to emit irradiation light under the light emission condition C. At the same time, these sections issue received-light pulses to drive each of the pixels 71 in the pixel array section 35, thereby starting reception of light.

Following the predetermined sensor startup operation (StartUp), the distance measuring sensor 12 receives reflected light under the light emission condition C. In so doing, the distance measuring sensor 12 generates a first micro frame of the phases of 0 and 180 degrees and then a second micro frame of the phases of 90 and 270 degrees. The distance measuring sensor 12 proceeds to generate a third depth frame on the basis of the first micro frame and the second micro frame.

The distance measuring sensor 12 then generates one depth map (first depth map) and a confidence map from the first through the third depth frames. The distance measuring sensor 12 outputs what is generated to the host control section 13 via the input/output terminal 39-5.

The above procedure completes the operations corresponding to one distance measurement start trigger. Meanwhile, it is the data processing section 37 that performs the processes of generating the micro frames, the depth frames, and the depth map based on the result of reception of the reflected light. In the drive corresponding to the next distance measurement start trigger, a depth map (second depth map) is generated under the light emission conditions at a different modulation frequency, for example.

As described above, the distance measuring sensor 12 acquires a set of multiple light emission conditions from the host control section 13, and in units of a depth frame, performs control to change the light emission conditions for the lighting apparatus 11.

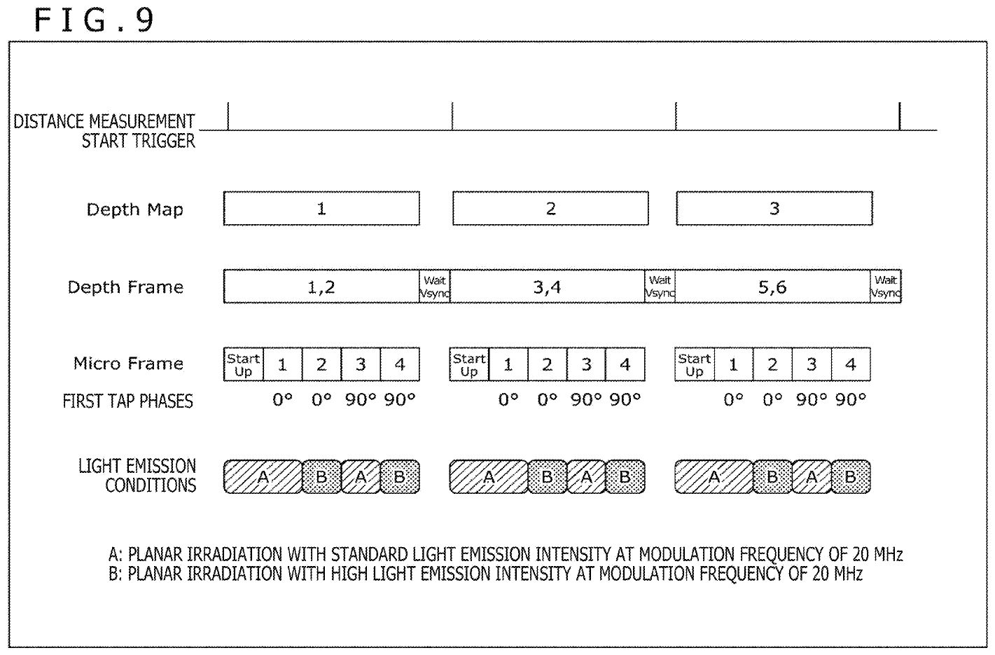

FIG. 9 is a sequence diagram depicting a second control example in which the distance measuring sensor 12 performs a change of light emission conditions for the lighting apparatus 11.

The example in FIG. 9 is one in which the distance measuring sensor 12 generates two depth frames under two kinds of light emission conditions A and B, generates one depth map from the two depth frames, and outputs the generated depth map. Since two micro frames are necessary for one depth frame in the case of the 2-Phase method, one depth map is generated by use of a total of four micro frames.

Before being supplied with the distance measurement start trigger from the host control section 13, the control section 31 in the distance measuring sensor 12 acquires a set of two kinds of light emission conditions A and B from the host control section 13 and stores the acquired light emission conditions in the internal memory. Here, the light emission condition A is assumed to be for performing overall irradiation with the standard light emission intensity at the modulation frequency of 20 MHz, for example. The light emission condition B is assumed to be for carrying out overall irradiation with a high light emission intensity level at the modulation frequency of 20 MHz, for example.

Here, the second control depicted in FIG. 9 differs from the first control in FIG. 8 in that the light emission conditions are changed not in units of a depth frame but in units of a micro frame.

Specifically, the control section 31 and the light emission timing control section 32 in the distance measuring sensor 12 output to the lighting apparatus 11 the light source setting information and light emission pulses corresponding to the light emission condition A, thereby causing the lighting apparatus 11 to emit irradiation light under the light emission condition A.

Following the predetermined sensor startup operation (StartUp), the distance measuring sensor 12 receives reflected light under the light emission condition A, and generates a first micro frame of the phases of 0 and 180 degrees.

Next, the control section 31 and the light emission timing control section 32 output to the lighting apparatus 11 the light source setting information and light emission pulses corresponding to the light emission condition B, thereby causing the lighting apparatus 11 to emit irradiation light under the light emission condition B.

The distance measuring sensor 12 receives reflected light under the light emission condition B, and generates a second micro frame of the phases of 0 and 180 degrees.

Next, the control section 31 and the light emission timing control section 32 output to the lighting apparatus 11 the light source setting information and light emission pulses corresponding to the light emission condition A, thereby causing the lighting apparatus 11 to emit irradiation light under the light emission condition A.

The distance measuring sensor 12 receives reflected light under the light emission condition A, and generates a third micro frame of the phases of 90 and 270 degrees.

Next, the control section 31 and the light emission timing control section 32 output to the lighting apparatus 11 the light source setting information and light emission pulses corresponding to the light emission condition B, thereby causing the lighting apparatus 11 to emit irradiation light under the light emission condition B.

The distance measuring sensor 12 receives reflected light under the light emission condition B, and generates a fourth micro frame of the phases of 90 and 270 degrees.

The distance measuring sensor 12 then generates a first depth frame on the basis of the first micro frame and the third micro frame under the light emission condition A, and generates a second depth frame on the basis of the second micro frame and the fourth micro frame under the light emission condition B.

Finally, the distance measuring sensor 12 generates one depth map (first depth map) and a confidence map from the first and the second depth frames. The distance measuring sensor 12 outputs what is generated to the host control section 13 via the input/output terminal 39-5.

The above procedure completes the operations corresponding to one distance measurement start trigger. The data processing section 37 performs the processes of generating the micro frames, the depth frames, and the depth map. In the drive corresponding to the next distance measurement start trigger, a depth map (second depth map) is generated under the light emission conditions at a different modulation frequency, for example.

As described above, the distance measuring sensor 12 can acquire in advance a set of multiple light emission conditions from the host control section 13 and perform control to change the light emission conditions for the lighting apparatus 11 in units of a micro frame. With the light emission conditions changed in units of a micro frame, it is possible to measure the distance to the measurement target object, even in the case of a moving subject being imaged, substantially at the same time under different light emission conditions.

Under the above-mentioned second control, in a case where depth frames are generated under different light emission conditions A and B, the following does not occur: two micro frames (one micro frame of the phases of 0 and 180 degrees and another micro frame of the phases of 90 and 270 degrees) necessary for one depth frame would be generated first under the light emission condition A, followed by another two micro frames necessary for another depth frame under the light emission condition B. Instead, the following takes place: a micro frame of the phases of 0 and 180 degrees is generated first under the light emission conditions A and B, followed by another micro frame of the phases of 90 and 270 degrees generated also under the light emission conditions A and B.

In such a manner, it is possible, not to consecutively generate two micro frames necessary for one depth frame under the same light emission condition, but to execute the drive to consecutively generate two micro frames of the same phase under different light emission conditions. Obviously, two micro frames necessary for one depth frame may be consecutively generated under the same light emission condition.

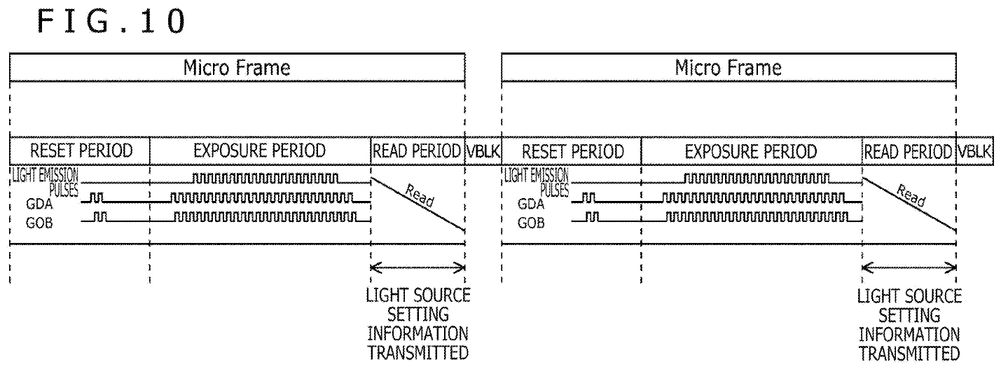

FIG. 10 is a diagram explaining a specific transmission timing at which the distance measuring sensor 12 transmits light source setting information to the lighting apparatus 11.

FIG. 10 depicts light emission pulses transmitted from the distance measuring sensor 12 to the lighting apparatus 11, as well as distribution signals GDA and GDB for distributing the charges generated by the photodiode 81 to the FD section 82A as the first tap and to the FD section 82B as the second tap.

A micro frame period in which the distance measuring sensor 12 generates one micro frame includes a reset period, an exposure period, and a read period. The reset period is a period in which each of the pixels 71 performs a reset operation to reset excess charges. The exposure period is a period in which each of the pixels 71 carries out an exposure operation. The read period is a period in which each of the pixels 71 outputs the detection signals corresponding to the accumulated charges to the column processing section 36.

The control section 31 in the distance measuring sensor 12 outputs the light source setting information to the lighting apparatus 11 when the operation timing of each pixel 71 corresponds to the read period. Because it controls the entire operations of the distance measuring sensor 12, the control section 31 keeps tabs on these operation timings. For this reason, although the unit time of one micro frame is as short as approximately hundreds to 20,000 fps when converted to frame rate, it is possible to transmit the light source setting information in real time even at high frame rates. In a case where the serial communication such as the SPI or I2C is used, complex and detailed settings are made possible by use of register settings.

As described above, the distance measuring sensor 12 acquires a set of multiple light emission conditions to be set for the lighting apparatus 11, and in keeping with the operations of its own, performs control to change the light emission conditions for the lighting apparatus 11. This eliminates the need for the host control section 13 to control the lighting apparatus 11. By performing control to change the light emission conditions for the lighting apparatus 11 at a timing commensurate with its own operations, the distance measuring sensor 12 can control the lighting apparatus 11 at high speed.

Whereas FIGS. 8 through 10 depict two examples, one in which the light emission conditions for the lighting apparatus 11 are changed in units of a depth frame and the other in which the light emission conditions for the lighting apparatus 11 are changed in units of a micro frame, it is also obviously possible to change the light emission conditions for the lighting apparatus 11 in units of a depth map.

### <5. First Modification Example of the Distance Measuring Sensor>

Modification examples of the distance measuring sensor 12 are explained below.

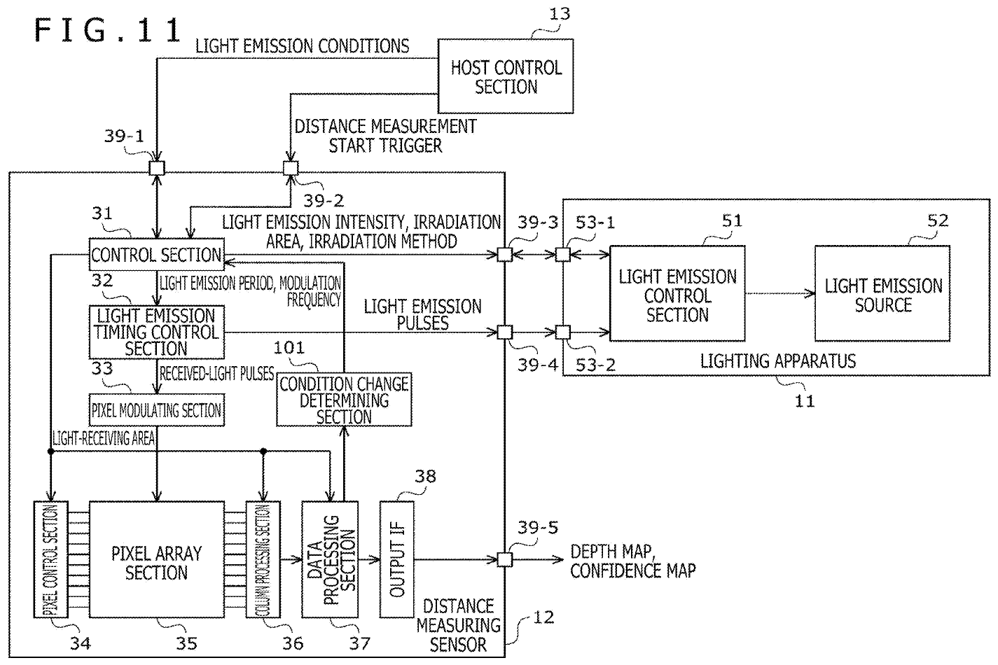

FIG. 11 is a block diagram depicting an exemplary detailed configuration of the lighting apparatus 11 and a first modification example of the distance measuring sensor 12.

In FIG. 11, the components corresponding to those in the exemplary configuration of the lighting apparatus 11 and the distance measuring sensor 12 in FIG. 4 are assigned the same reference signs, and redundant explanations are omitted.

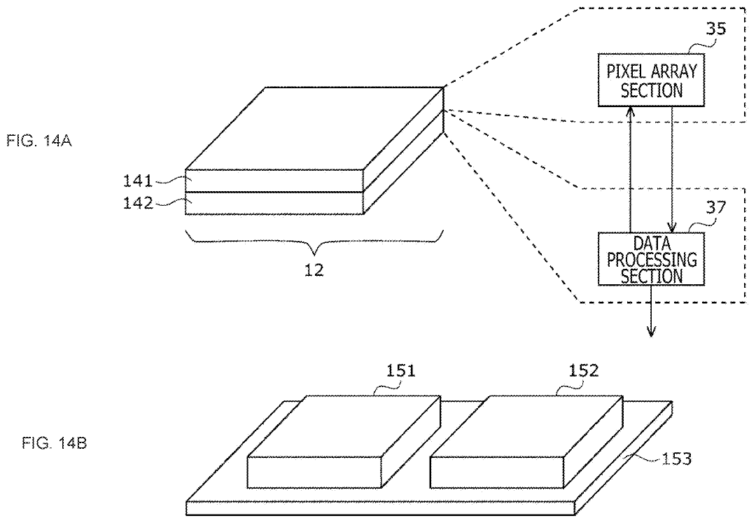

The first modification example of the distance measuring sensor 12 is formed by the exemplary configuration of the distance measuring sensor 12 in FIG. 14 supplemented with a condition change determining section 101 that is added anew. The remaining components are the same as those of the distance measuring sensor 12 in FIG. 4.

The first modification example of the distance measuring sensor 12 not only has the function of performing control to change the multiple light emission conditions acquired from the host control section 13 in units of a micro frame, a depth frame, or a depth map in a predetermined sequence as with the above-described distance measuring sensor 12 in FIG. 4, but also provides the function of performing control to determine and change on its own the light emission conditions for the lighting apparatus 11 according to the result of reception of reflected light.

The condition change determining section 101 acquires a depth frame and a confidence frame generated by the data processing section 37. On the basis of the acquired depth frame and confidence frame, the condition change determining section 101 determines the light emission conditions to be set in the next depth frame and supplies what is determined to the control section 31.

In accordance with the light emission conditions supplied from the condition change determining section 101, the control section 31 controls the operations of the lighting apparatus 11 and those of its own. That is, the control section 31 supplies the light source setting information such as the light emission intensity to the lighting apparatus 11 and supplies the information of the modulation frequency and the light emission period to the light emission timing control section 32. Also, the control section 31 supplies the drive control information to the pixel control section 34, the column processing section 36, and the data processing section 37.

For example, in a case where the condition change determining section 101 determines that a subject requiring highly accurate imaging is being imaged, the condition change determining section 101 changes the light emission conditions, on the basis of a measured distance value of the depth frame, in such a manner that the irradiation area is changed from the overall area to a partial area covering only the subject as depicted in Subfigure A in FIG. 7, or in such a manner that the light emission intensity is raised as illustrated in Subfigure B in FIG. 7. Whether or not the subject requires highly accurate imaging can be determined by checking whether the measured distance value represents a close range. For example, in a case where there is a measurement error of 5 cm, a measured distance value of 1 m is more affected by the error than a measured distance value of 7 m. Therefore, in cases where the measured distance value is equal to or less than a predetermined short-range value (e.g., 1 m), it can be determined that a subject requiring highly accurate imaging is being imaged. In the case where the irradiation area is limited to only the area of the subject instead of covering the whole area, the light-receiving area of the pixel array section 35 can also be changed to drive only a partial area corresponding to the limited subject area.

As another example, the condition change determining section 101 may determine whether the measured distance value of the depth frame indicates as being one acquired in an indoor environment. In the case where the measurement is determined to have been acquired in the indoor environment, the condition change determining section 101 changes the light emission conditions in such a manner as to replace planar irradiation with spot irradiation as depicted in Subfigure A in FIG. 6. Whether or not the measured distance value is acquired in the indoor environment can be determined on the basis of the difference between the distance to the foreground on one hand and the distance to the background on the other hand or of the measured value of distance (i.e., its magnitude) to the background. In the case where the measurement is determined to have been obtained in the indoor environment, the effects of irregular reflection are significant. The distance measuring sensor 12 then performs distance measurement using spot irradiation to acquire data regarding a bright area (spot area) and a dark area (area other than the spot). Acquisition of the data regarding the dark area affected by the irregular reflection permits signal processing that removes irregular reflection components, which improves the accuracy of distance measurement. As another example, in a case where a measured distance value presumed to be a noise stemming from irregular reflection is obtained, the accuracy of distance measurement can be enhanced by measuring the distance with spot irradiation that suppresses the effects of irregular reflection.

As a further example, in a case where the condition change determining section 101 determines that the light emission intensity is high, on the basis of the confidence (confidence frame) indicative of the intensity of received reflected light, the condition change determining section 101 can change the light emission conditions to lower the light emission intensity. On the other hand, in a case where the condition change determining section 101 determines that the light emission intensity is low, the condition change determining section 101 can change the light emission conditions to increase the light emission intensity.

In the above-described examples, the condition change determining section 101 determines the light emission conditions on the basis of the depth frame or on the confidence frame. Alternatively, the condition change determining section 101 may determine the light emission conditions on the basis of the depth map or on the confidence map. The condition change determining section 101 may further determine a change of the light emission conditions on the basis of the detection signals output from each of the pixels. For example, the light emission intensity can be changed depending on whether or not the detection signals indicate a saturated state of the pixels.

Incidentally, in the distance measuring sensor 12 in FIG. 11, the condition change determining section 101 may be implemented as part of the data processing section 37 or as part of the control section 31.

### <6. Second Modification Example of the Distance Measuring Sensor>

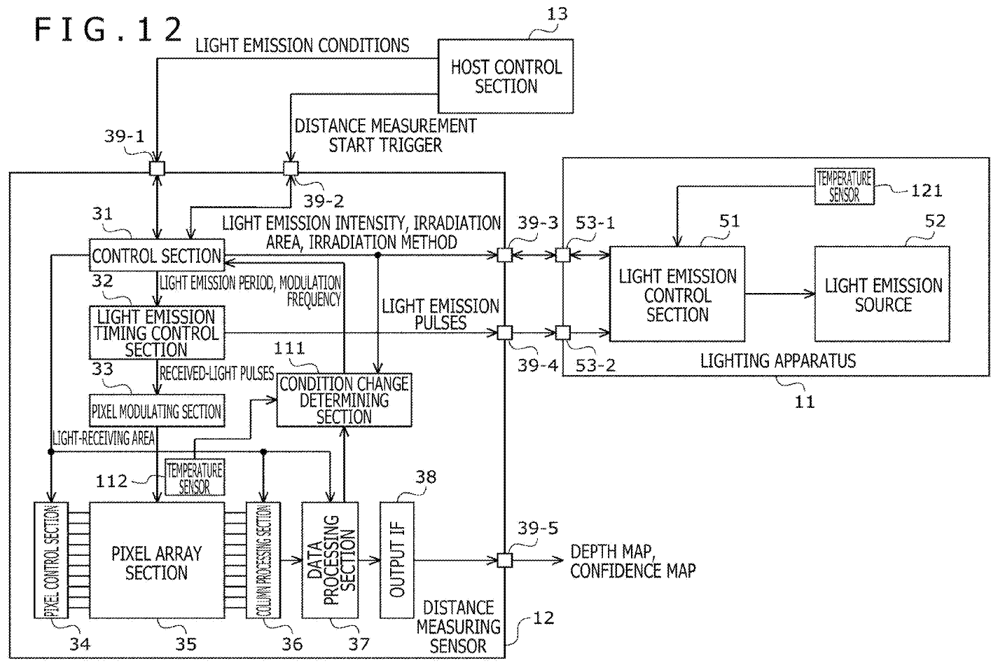

FIG. 12 is a block diagram depicting an exemplary detailed configuration of the lighting apparatus 11 and a second modification example of the distance measuring sensor 12.

In FIG. 12, the components corresponding to those in the exemplary configuration of the lighting apparatus 11 and the distance measuring sensor 12 in FIG. 4 are assigned the same reference signs, and redundant explanations are omitted.

The second modification example of the distance measuring sensor 12 is constituted by the exemplary configuration of the distance measuring sensor 12 in FIG. 14 supplemented with a condition change determining section 111 and a temperature sensor 112 which are added anew. The remaining components are the same as those of the distance measuring sensor 12 in FIG. 4. A temperature sensor 121 is also added anew to the lighting apparatus 11.

The condition change determining section 111 is supplied with a pixel temperature inside the pixel array section 35 from the temperature sensor 112. Also, the temperature (light source temperature) of the light emission source 52 (laser light source) detected by the temperature sensor 121 in the lighting apparatus 11 is supplied from the lighting apparatus 11 to the condition change determining section 111 via the input/output terminals 53-1 and 39-3.

The condition change determining section 111 determines the light emission conditions to be set in the next depth frame, on the basis of the environmental conditions during distance measurement, specifically, on the basis of the pixel temperature detected by the temperature sensor 112 and on the light source temperature detected in the lighting apparatus 11. The condition change determining section 111 supplies what is thus determined to the control section 31. Alternatively, the condition change determining section 111 may determine the light emission conditions on the basis of either the pixel temperature or the light source temperature.

For example, in a case where the light source temperature supplied from the lighting apparatus 11 is determined to be high (i.e., higher than a predetermined temperature), the condition change determining section 111 changes the light emission conditions to lower the light emission intensity or to shorten the light emission period. As another example, in a case where the pixel temperature supplied from the temperature sensor 112 is determined to be high (i.e., higher than a predetermined temperature), the condition change determining section 111 changes the light emission conditions to shorten the exposure time (equivalent to the light emission period). In a case where the pixel temperature is high and the light source temperature is low, it is possible to suppress the deterioration of accuracy due to a drop in the amount of received light by increasing the light emission intensity while changing the exposure period at the same time.

Located near the pixels in the pixel array section 35, the temperature sensor 112 detects the pixel temperature and supplies the detected temperature to the condition change determining section 111. There may be multiple temperature sensors 112 arranged inside the pixel array section 35.

The temperature sensor 121 in the lighting apparatus 11 is located near the light emission source 52. The temperature sensor 121 detects the light source temperature and supplies the detected temperature to the light emission control section 51.

Incidentally, in the distance measuring sensor 12 in FIG. 12, the condition change determining section 111 may be implemented as part of the data processing section 37 or as part of the control section 31.

The change of light emission conditions based on the result of detection by the temperature sensors 112 and 121 may be performed in units of either a depth frame or a depth map, as in the case of the first modification example.

### <7. Flowchart of the Light Emission Condition Control Process>

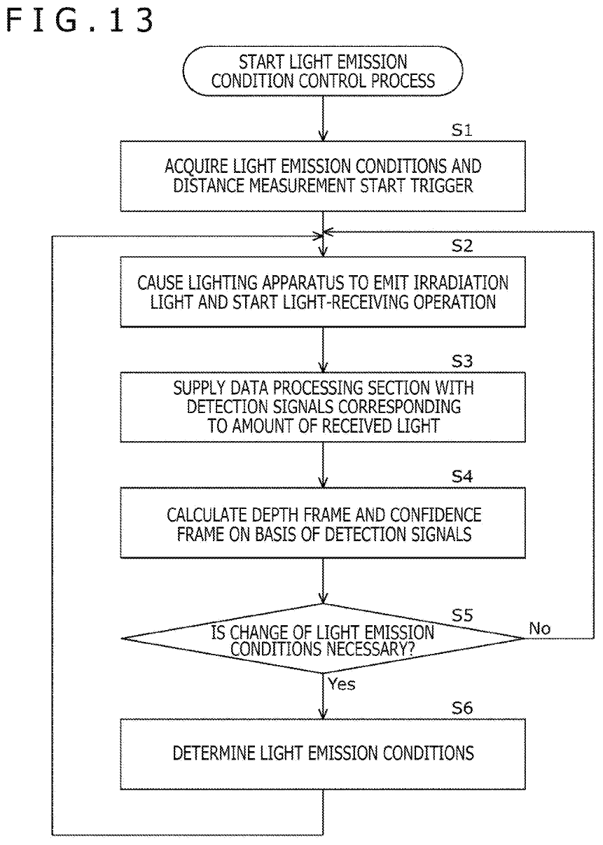

Explained next with reference to the flowchart of FIG. 13 is a light emission condition control process performed by the first modification example of the distance measuring sensor 12. This process is started, for example, when a light emission condition and a distance measurement start trigger are supplied from the host control section 13.

First, in step S1, the control section 31 of the distance measuring sensor 12 acquires light emission conditions and a distance measurement start trigger supplied from the host control section 13. There may be a single light emission condition or a set of multiple light emission conditions.

In step S2, the control section 31 causes the lighting apparatus 11 to emit irradiation light under predetermined light emission conditions and starts operations of its own to receive light. More specifically, the control section 31 outputs to the lighting apparatus 11 the light source setting information and light emission pulses corresponding to the predetermined light emission conditions. At the same time, the control section 31 supplies the information regarding a light emission period and a modulation frequency to the light emission timing control section 32. On the basis of the light emission period and modulation frequency information, the light emission timing control section 32 generates light emission pules and supplies what is generated to the lighting apparatus 11. At the same time, the light emission timing control section 32 supplies received-light pulses to the pixel modulating section 33. Further, the control section 31 supplies drive control information including the light-receiving area of the pixel array section 35 to the pixel control section 34, the column processing section 36, and the data processing section 37. The lighting apparatus 11 emits irradiation light on the basis of the light source setting information and light emission pulses from the distance measuring sensor 12.

In step S3, under control of the pixel modulating section 33 and the pixel control section 34, the pixels 71 in the pixel array section 35 receive reflected light from the object under irradiation light from the lighting apparatus 11, and supply the data processing section 37 with detection signals corresponding to the amount of the received light in units of a pixel.

In step S4, on the basis of the detection signals from the pixels 71, the data processing section 37 calculates a depth frame and a confidence frame, and supplies the calculated depth frame and confidence frame to the condition change determining section 101.

In step S5, the condition change determining section 101 determines whether a change of the light emission condition is necessary, on the basis of the depth frame and confidence frame from the data processing section 37. For example, as discussed above, the condition change determining section 101 determines whether a subject requiring highly accurate imaging is being imaged, or whether the distance is measured in an indoor environment.

In a case where a change of the light emission conditions is determined to be unnecessary in step S5, control is returned to step S2, and steps S2 through S5 are repeated as described above. In this case, the light emission conditions are left unchanged while the irradiation light is being emitted and the reflected light is being received.

On the other hand, in a case where a change of the light emission conditions is determined to be necessary in step S5, control is transferred to step S6. In step S6, the light emission conditions to be set in the next depth frame are determined and supplied to the control section 31. Thereafter, control is returned to step S2, and steps S2 through S5 are repeated as described above. In this case, the irradiation light is emitted and the reflected light is received under the changed light emission conditions.

The light emission condition control process in FIG. 13 is terminated in such cases as where a predetermined termination condition is met, e.g., where a predetermined number of depth maps and a predetermined number of confidence maps have been output.

The above-described light emission condition control process enables the distance measuring sensor 12 to determine on its own the light emission conditions for the lighting apparatus 11 in keeping with the result of reception of reflected light, and to perform control to change the light emission conditions accordingly.

Whereas the flowchart in FIG. 13 depicts an example of the light emission condition control process performed by the first modification example of the distance measuring sensor 12, the second modification example of the distance measuring sensor 12 can likewise determine the light emission conditions on the basis of the result of detection by the temperature sensors 112 and 121 and perform control to change the light emission conditions accordingly.

### <8. Exemplary Chip Configuration of the Distance Measuring Sensor>

FIG. 14 is a perspective diagram depicting an exemplary chip configuration of the distance measuring sensor 12.

The distance measuring sensor 12 can be configured with one chip on which a first die (substrate) 141 and a second die (substrate) 142 are stacked one on top of the other as depicted in Subfigure A in FIG. 14.

The first die 141 includes at least the pixel array section 35 as the light receiving section, for example. The second die 142 includes, for example, the data processing section 37 that performs the process of generating depth frames and depth maps by using the detection signals output from the pixel array section 35.

Alternatively, the distance measuring sensor 12 may be configured in a three-layer structure supplementing the first die 141 and the second die 142 with another logic die stacked thereon. As another alternative, the distance measuring sensor 12 may be configured in a structure of four or more dies (substrates) being stacked one on top of another.

Part of the functions of the distance measuring sensor 12 can be taken over by an independent signal processing chip in another configuration. For example, as depicted in Subfigure B in FIG. 14, a sensor chip 151 acting as the distance measuring sensor 12 and a logic chip 152 that carries out signal processing downstream can be formed on a relay substrate 153. The logic chip 152 can be configured to perform some of the above-described processes performed by the data processing section 37 in the distance measuring sensor 12, such as the process of generating depth frames and depth maps.

<9. Comparisons with Other Light Emission Control Methods>

The above-described distance measuring system 1 is configured in such a manner that the host control section 13 supplies the light emission conditions for the lighting apparatus 11 to the distance measuring sensor 12 and in such a manner that the distance measuring sensor 12 controls the light emission by the lighting apparatus 11 on the basis of the acquired light emission conditions.

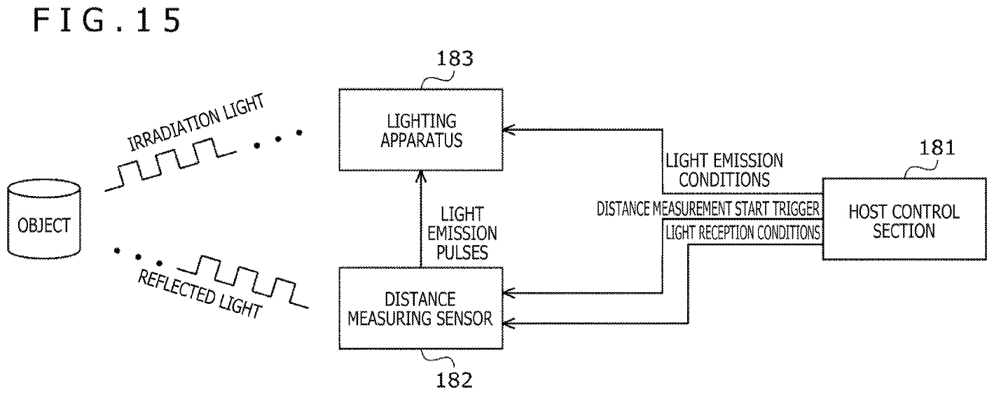

In comparison, as depicted in FIG. 15, there may be a method by which a host control section 181 supplies light emission conditions to a lighting apparatus 183 and sends light reception conditions corresponding to the light emission conditions to a distance measuring sensor 182. The light reception conditions corresponding to the light emission conditions include, for example, a modulation frequency and an exposure period corresponding to the light emission period. As with the distance measuring system 1 in FIG. 1, a distance measurement start trigger is supplied from the host control section 181 to the distance measuring sensor 182. Light emission pulses are generated by the distance measuring sensor 182 and supplied to the lighting apparatus 183.

According to such a control method, in a case where the host control section 181 changes the light emission conditions and supplies the new light emission conditions to the lighting apparatus 183, it is necessary for the lighting apparatus 183 to temporarily stop its light emission. This also requires stopping the output of the light emission pulses, which in turn necessitates temporarily stopping the operation of the distance measuring sensor 182. Since the light emission pulses are generated and output in synchronism with the distance measurement starting operation carried out upon receipt of a distance measurement start trigger, stopping the output of the light emission pulses requires the host control section 181 to again output the distance measurement start trigger.

That is, according to the control method of the distance measuring system in FIG. 15, the light emission conditions are changed at each timing at which the distance measurement start trigger is output. This means that the light emission conditions can be changed only in units of a depth map.

By contrast, the distance measuring system 1 in FIG. 1 allows the light emission conditions to be changed not only in units of a depth map but also in units of a depth frame or a micro frame. This makes it possible to change the light emission conditions at speeds high enough to follow scene changes.

Because the host control section 13 is not involved in control of changing the light emission conditions, the host control section 13 itself can enter a stopped state (standby state) after outputting the distance measurement start trigger. This can contribute to reducing the power consumption of the entire host apparatus in which the distance measuring system 1 is incorporated.

The method by which the distance measuring system 1 in FIG. 1 controls the change of light emission conditions is not limited to the indirect ToF method. Alternatively, the Structured Light method or the direct ToF method may be used by the distance measuring system.

### <10. Examples of Application to Electronic Equipment>

The above-described distance measuring system 1 can be incorporated in such electronic equipment as smartphones, tablet terminals, mobile phones, personal computers, game machines, TV sets, wearable terminals, digital still cameras, and digital video cameras, for example.

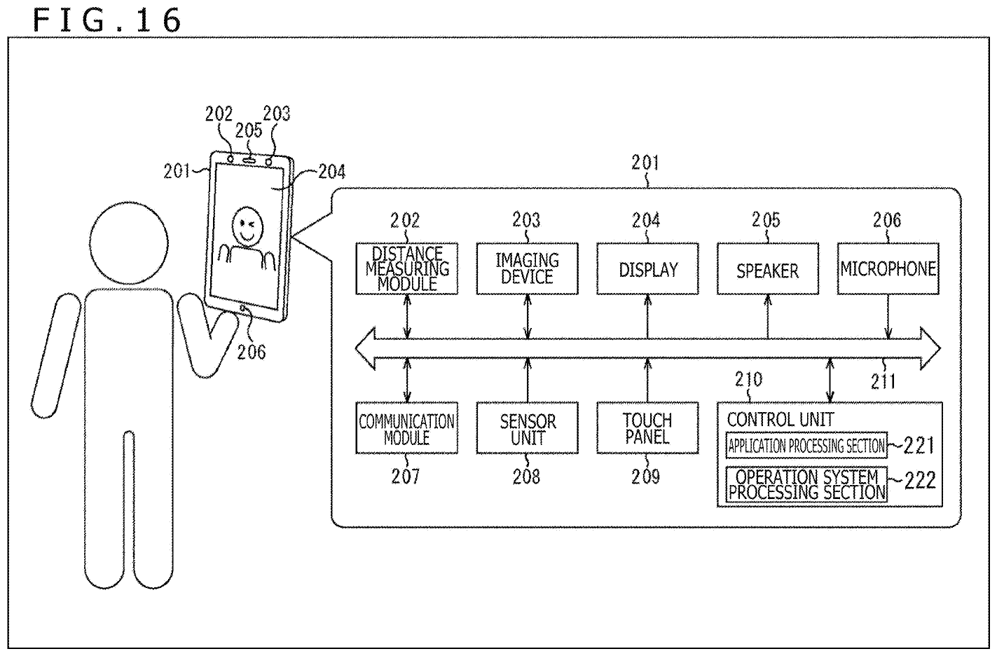

FIG. 16 is a block diagram depicting an exemplary configuration of a smartphone as electronic equipment in which the distance measuring system 1 is incorporated.

As depicted in FIG. 16, a smartphone 201 includes a distance measuring module 202, an imaging device 203, a display 204, a speaker 205, a microphone 206, a communication module 207, a sensor unit 208, a touch panel 209, and a control unit 210, all being interconnected with one another via a bus 211. The control unit 210 with its CPU executing programs offers the functions of an application processing section 221 and of an operation system processing section 222.

The distance measuring system 1 of FIG. 1 is applied to the distance measuring module 202. For example, the distance measuring module 202 is arranged at the front face of the smartphone 201 to measure the distance to the user of the smartphone 201. This makes it possible to output depth values of the user's surface profile such as the face, hands, and fingers as a result of the distance measurement. The host control section 13 in FIG. 1 corresponds to the control unit 210 in FIG. 16.

The imaging device 203 is arranged at the front face of the smartphone 201 to image the user of the smartphone 201 as the subject being imaged, thereby acquiring images of the user. Although not depicted, the imaging device 203 may also be arranged at the back face of the smartphone 201.

The display 204 displays operation screens for performing processes by the application processing section 221 and by the operation system processing section 222, as well as images captured by the imaging device 203. During a call with the smartphone 201, for example, the speaker 205 and the microphone 206 output the other party's voice and pick up the user' voice.

The communication module 207 conducts communication over communication networks. The sensor unit 208 senses speeds, acceleration, and proximity, among others. The touch panel 209 acquires touch operations made by the user on the operation screen displayed on the display 204.

The application processing section 221 performs processes for enabling the smartphone 201 to offer diverse services. For example, on the basis of the depth map supplied from the distance measuring module 202, the application processing section 221 can perform the processes of creating a human face virtually reproducing the user's expression by means of computer graphics and of displaying what is created on the display 204. Also, on the basis of the depth map supplied from the distance measuring module 202, the application processing section 221 can perform, for example, the process of generating three-dimensional data of a desired cubic object.

The operation system processing section 222 performs processes for enabling the smartphone 201 to implement basic functions and activities. For example, on the basis of the depth map supplied from the distance measuring module 202, the operation system processing section 222 can authenticate the user's face to execute the process of unlocking the smartphone 201. Also, on the basis of the depth map supplied from the distance measuring module 202, the operation system processing section 222 can perform, for example, the processes of recognizing user's gestures and of inputting various operations according to the recognized gestures.

When applied to the smartphone 201 configured as explained above, the above-described distance measuring system 1 can generate highly accurate depth maps at high speed, for example. This enables the smartphone 201 to detect distance measurement information more precisely than before.

### <11. Examples of Application to Mobile Objects>

The technology of the present disclosure (the present technology) can be applied to diverse products. For example, the technology of the present disclosure may be implemented as an apparatus to be mounted on such mobile objects as automobiles, electric vehicles, hybrid electric vehicles, motorcycles, bicycles, personal mobility devices, aircraft, drones, ships, and robots.

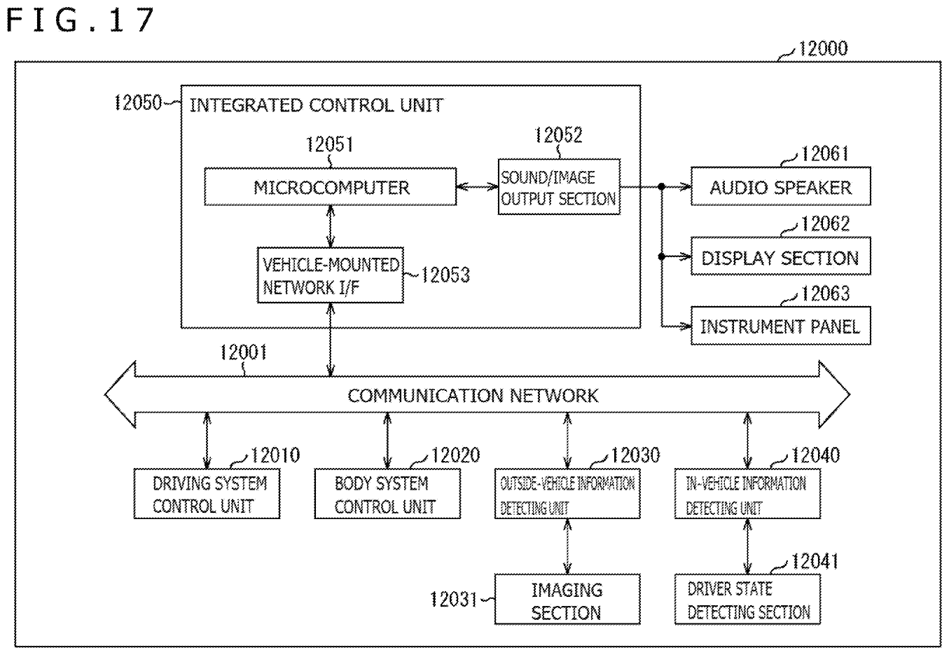

FIG. 17 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 17, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 17, an audio speaker 12061, a display section 12062, and an instrument panel 12063 are illustrated as the output device. The display section 12062 may, for example, include at least one of an on-board display and a head-up display.

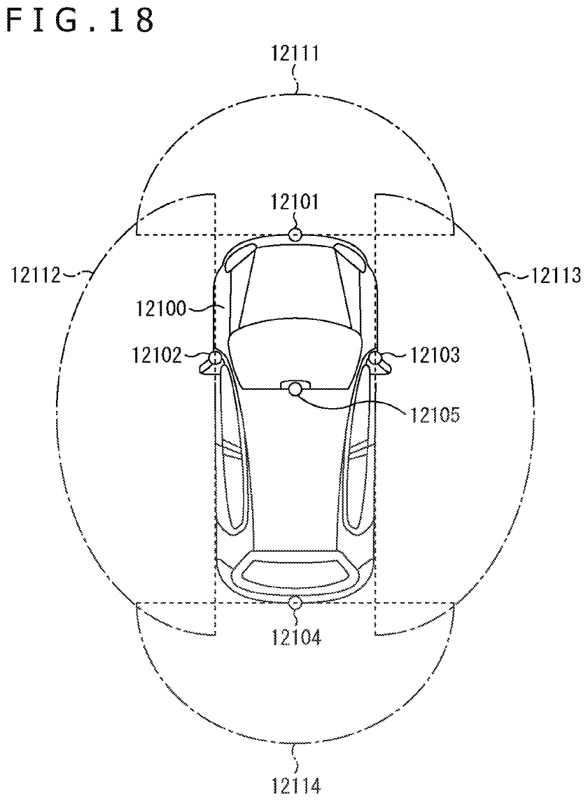

FIG. 18 is a diagram depicting an example of the installation position of the imaging section 12031.

In FIG. 18, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 18 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

Described above is one example of the vehicle control system to which the technology of the present disclosure can be applied. The technology of the present disclosure can be applied to the outside-vehicle information detecting unit 12030 or to the in-vehicle information detecting unit 12040 among the above-descried components. Specifically, by use of distance measurement with the distance measuring system 1 implemented as the outside-vehicle information detecting unit 12030 or as the in-vehicle information detecting unit 12040, it is possible to perform the process of recognizing the driver's gestures to carry out diverse operations (e.g., of an audio system, a navigation system, and an air-conditioning system) as per the recognized gestures or to detect the driver's state more accurately. Furthermore, the use of distance measurement by the distance measuring system 1 makes it possible to recognize an uneven road surface and to have the recognized unevenness reflected in suspension control.

The embodiments of the present technology are not limited to those discussed above and can be modified or altered diversely within the scope of this technology.

The multiple elements of the present technology explained in this description can be implemented independently of each other, provided there occurs no conflict therebetween. Obviously, any multiple elements of the present technology can be implemented in combination. Further, part or all of the elements of the above-described present technology can be implemented in combination with techniques not discussed in the present description.

Further, any configuration explained in the foregoing paragraphs as one apparatus (or processing section) may be divided into multiple apparatuses (or processing sections). Conversely, the configurations explained above as multiple apparatuses (or processing sections) may be unified into one apparatus (or processing section). Also, the configuration of each apparatus (or processing section) may obviously be supplemented with a configuration or configurations other than those discussed above. Further, part of the configuration of an apparatus (or processing section) may be included in the configuration of another apparatus (or processing section), provided the configurations and the workings remain substantially the same for the system as a whole.

Furthermore, in this description, the term “system” refers to an aggregate of multiple components (e.g., apparatuses or modules (parts)). It does not matter whether or not all components are housed in the same enclosure. Thus, a system may be configured with multiple apparatuses housed in separate enclosures and interconnected via a network, or with a single apparatus in a single enclosure that houses multiple modules.

It is to be noted that the advantageous effects stated in this description are only examples and not limitative of the present disclosure that may provide other advantages as well.

It is to be noted that the present technology can be implemented in the following configurations.
(1)

A distance measuring sensor including:

a pixel array section configured to have pixels arrayed two-dimensionally, each of the pixels receiving reflected light from an object under irradiation light from a lighting apparatus and outputting a detection signal corresponding to an amount of the received light; and

a control section configured to control a light emission condition for the lighting apparatus according to an operation of each of the pixels in the pixel array section.
(2)

The distance measuring sensor as stated in paragraph (1) above, in which the control section performs control to change the light emission condition for the lighting apparatus during a pixel read period in which the detection signal is output from each of the pixels.
(3)

The distance measuring sensor as stated in paragraph (1) or (2) above, in which the control section performs control to change a light emission source in controlling the light emission condition for the lighting apparatus.
(4)

The distance measuring sensor as stated in any one of paragraphs (1) through (3) above, in which the control section performs control to change a modulation frequency in controlling the light emission condition for the lighting apparatus.
(5)

The distance measuring sensor as stated in any one of paragraphs (1) through (4) above, in which the control section performs control to change an irradiation method in controlling the light emission condition for the lighting apparatus.
(6)

The distance measuring sensor as stated in any one of paragraphs (1) through (5) above, in which the control section performs control to change light emission intensity in controlling the light emission condition for the lighting apparatus.
(7)

The distance measuring sensor as stated in any one of paragraphs (1) through (6) above, in which the control section performs control to change an irradiation area in controlling the light emission condition for the lighting apparatus.
(8)

The distance measuring sensor as stated in any one of paragraphs (1) through (7) above, in which the control section performs control to change the light emission condition for the lighting apparatus in units of a micro frame.
(9)

The distance measuring sensor as stated in any one of paragraphs (1) through (8) above, in which the control section performs control to change the light emission condition for the lighting apparatus in units of a depth frame.
(10)

The distance measuring sensor as stated in any one of paragraphs (1) through (9) above, in which the control section supplies the lighting apparatus with the light emission condition acquired from a broader-concept control section for the lighting apparatus, in keeping with a timing commensurate with the operation of each of the pixels in the pixel array section.
(11)

The distance measuring sensor as stated in any one of paragraphs (1) through (10) above, in which the control section determines the light emission condition for the lighting apparatus according to a light reception result of each of the pixels in the pixel array section, the control section further supplying the lighting apparatus with the determined light emission condition in keeping with a timing commensurate with the operation of each of the pixels in the pixel array section.
(12)

The distance measuring sensor as stated in paragraph (11) above, in which the control section determines the light emission condition for the lighting apparatus according to a measured distance value based on the light reception result of each of the pixels in the pixel array section.
(13)

The distance measuring sensor as stated in paragraph (12) above, in which the control section determines the light emission condition for the lighting apparatus depending on whether or not the measured distance value represents a close range.
(14)

The distance measuring sensor as stated in paragraph (12) above, in which the control section determines the light emission condition for the lighting apparatus depending on whether or not the measured distance value represents measurement in an indoor environment.
(15)

The distance measuring sensor as stated in any one of paragraphs (1) through (14) above, in which the control section determines the light emission condition for the lighting apparatus according to an environmental condition, the control section further supplying the lighting apparatus with the determined light emission condition in keeping with a timing commensurate with the operation of each of the pixels in the pixel array section.
(16)

The distance measuring sensor as stated in paragraph (15) above, further including:

a temperature sensor for measuring an internal temperature,

in which the control section determines the light emission condition for the lighting apparatus on the basis of a detection result of the temperature sensor as the environmental condition.
(17)

The distance measuring sensor as stated in paragraph (15) above, in which the control section determines the light emission condition for the lighting apparatus on the basis of a detection result of a temperature sensor in the lighting apparatus as the environmental condition.
(18)

A distance measuring system including:

a lighting apparatus configured to emit irradiation light to an object; and

a distance measuring sensor configured to receive reflected light from the object under the irradiation light,

the distance measuring sensor including
a pixel array section configured to have pixels arrayed two-dimensionally, each of the pixels receiving the reflected light and outputting a detection signal corresponding to an amount of the received light, and
a control section configured to control a light emission condition for the lighting apparatus according to an operation of each of the pixels in the pixel array section.
(19)

Electronic equipment including:

a distance measuring system including
a lighting apparatus configured to emit irradiation light to an object, and
a distance measuring sensor configured to receive reflected light from the object under the irradiation light,
the distance measuring sensor including
   a pixel array section configured to have pixels arrayed two-dimensionally, each of the pixels receiving the reflected light and outputting a detection signal corresponding to an amount of the received light, and
   a control section configured to control a light emission condition for the lighting apparatus according to an operation of each of the pixels in the pixel array section.

### REFERENCE SIGNS LIST

1: Distance measuring system

11: Lighting apparatus

12: Distance measuring sensor

13: Host control section

31: Control section

32: Light emission timing control section

37: Data processing section

51: Light emission control section

52: Light emission source

71: Pixel

101: Condition change determining section

111: Condition change determining section

112: Temperature sensor

201: Smartphone

202: Distance measuring module

121: Temperature sensor

LD1: First laser light source

LD2: Second laser light source

LD3: Third laser light source

1. A distance measuring sensor comprising:
a pixel array section configured to have pixels arrayed two-dimensionally, each of the pixels receiving reflected light from an object under irradiation light from a lighting apparatus and outputting a detection signal corresponding to an amount of the received light; and
a control section configured to control a light emission condition for the lighting apparatus according to an operation of each of the pixels in the pixel array section.

2. The distance measuring sensor according to claim 1, wherein the control section performs control to change the light emission condition for the lighting apparatus during a pixel read period in which the detection signal is output from each of the pixels.

3. The distance measuring sensor according to claim 1, wherein the control section performs control to change a light emission source in controlling the light emission condition for the lighting apparatus.

4. The distance measuring sensor according to claim 1, wherein the control section performs control to change a modulation frequency in controlling the light emission condition for the lighting apparatus.

5. The distance measuring sensor according to claim 1, wherein the control section performs control to change an irradiation method in controlling the light emission condition for the lighting apparatus.

6. The distance measuring sensor according to claim 1, wherein the control section performs control to change light emission intensity in controlling the light emission condition for the lighting apparatus.

7. The distance measuring sensor according to claim 1, wherein the control section performs control to change an irradiation area in controlling the light emission condition for the lighting apparatus.

8. The distance measuring sensor according to claim 1, wherein the control section performs control to change the light emission condition for the lighting apparatus in units of a micro frame.

9. The distance measuring sensor according to claim 1, wherein the control section performs control to change the light emission condition for the lighting apparatus in units of a depth frame.

10. The distance measuring sensor according to claim 1, wherein the control section supplies the lighting apparatus with the light emission condition acquired from a broader-concept control section for the lighting apparatus, in keeping with a timing commensurate with the operation of each of the pixels in the pixel array section.

11. The distance measuring sensor according to claim 1, wherein the control section determines the light emission condition for the lighting apparatus according to a light reception result of each of the pixels in the pixel array section, the control section further supplying the lighting apparatus with the determined light emission condition in keeping with a timing commensurate with the operation of each of the pixels in the pixel array section.

12. The distance measuring sensor according to claim 11, wherein the control section determines the light emission condition for the lighting apparatus according to a measured distance value based on the light reception result of each of the pixels in the pixel array section.

13. The distance measuring sensor according to claim 12, wherein the control section determines the light emission condition for the lighting apparatus depending on whether or not the measured distance value represents a close range.

14. The distance measuring sensor according to claim 12, wherein the control section determines the light emission condition for the lighting apparatus depending on whether or not the measured distance value represents measurement in an indoor environment.

15. The distance measuring sensor according to claim 1, wherein the control section determines the light emission condition for the lighting apparatus according to an environmental condition, the control section further supplying the lighting apparatus with the determined light emission condition in keeping with a timing commensurate with the operation of each of the pixels in the pixel array section.

16. The distance measuring sensor according to claim 15, further comprising:
a temperature sensor for measuring an internal temperature,
wherein the control section determines the light emission condition for the lighting apparatus on a basis of a detection result of the temperature sensor as the environmental condition.

17. The distance measuring sensor according to claim 15, wherein the control section determines the light emission condition for the lighting apparatus on a basis of a detection result of a temperature sensor in the lighting apparatus as the environmental condition.

18. A distance measuring system comprising:
a lighting apparatus configured to emit irradiation light to an object; and
a distance measuring sensor configured to receive reflected light from the object under the irradiation light,
the distance measuring sensor including
a pixel array section configured to have pixels arrayed two-dimensionally, each of the pixels receiving the reflected light and outputting a detection signal corresponding to an amount of the received light, and
a control section configured to control a light emission condition for the lighting apparatus according to an operation of each of the pixels in the pixel array section.

19. Electronic equipment comprising:
a distance measuring system including
a lighting apparatus configured to emit irradiation light to an object, and
a distance measuring sensor configured to receive reflected light from the object under the irradiation light,
the distance measuring sensor including
a pixel array section configured to have pixels arrayed two-dimensionally, each of the pixels receiving the reflected light and outputting a detection signal corresponding to an amount of the received light, and
a control section configured to control a light emission condition for the lighting apparatus according to an operation of each of the pixels in the pixel array section.
